(19) United States
(12) Patent Application Publication
(10) Pub. No.: US 2020/0355221 A1
(43) Pub. Date: Nov. 12, 2020

(54) MULTI-LAYER SLIDING BEARING ELEMENT

(71) Applicant: Miba Gleitlager Austria GmbH, Laakirchen (AT)

(72) Inventors: Alexander EBERHARD, Gschwandt (AT); Matthias SCHINAGL, Linz (AT)

(73) Assignee: Miba Gleitlager Austria GmbH, Laakirchen (AT)

(21) Appl. No.: 16/856,575

(22) Filed: Apr. 23, 2020

(30) Foreign Application Priority Data
May 7, 2019 (AT) A50412/2019

(51) Int. Cl. F16C 33/12; F16C 17/02

(52) U.S. Cl. CPC F16C 33/122; F16C 17/02

(57) ABSTRACT

A multi-layer sliding bearing element made from a composite material includes a supporting metal layer and a further layer formed of a cast alloy of a leadfree copper base alloy, in which sulfide precipitates are contained. The copper base alloy contains between 0.1 wt. % and 3 wt. % sulfur, between 0.01 wt. % and 4 wt. % iron, up to 2 wt. % phosphorus, at least one element from a first group consisting of zinc, tin, aluminum, manganese, nickel, silicon, chromium, indium of in total between 0.1 wt. % and 49 wt. %, and at least one element from a second group consisting of silver, magnesium, indium, cobalt, titanium, zirconium, arsenic, lithium, yttrium, calcium, vanadium, molybdenum, tungsten, antimony, selenium, tellurium, bismuth, niobium, palladium, wherein the summary proportion of the elements of the second group amounts to between 0 wt. % and 2 wt. %, and the balance is constituted by copper.

### CROSS REFERENCE TO RELATED APPLICATIONS

Applicant claims priority under 35 U.S.C. § 119 of Austrian Application No. A50412/2019 filed on May 7, 2019, the disclosure of which is incorporated by reference.

### BACKGROUND OF THE INVENTION

### 1. Field of the Invention

The invention relates to a multi-layer sliding bearing element made from a composite material comprising a supporting metal layer and a further layer, in particular a sliding layer, as well as optionally an intermediate layer between the supporting metal layer and the further layer, wherein the further layer is formed of a cast alloy of a lead-free copper base alloy in which sulfide precipitates are contained.

Lead bronzes have been used in multi-layer sliding bearing element made from a composite material comprising a supporting metal layer and a sliding layer for a long time in motor industry, since they show a good-natured tribological behavior due to the lead precipitations. Moreover, from a process-technical point of view, their production by casting is very robust, since the metallurgical phenomena of microseparation and the related formation of blowholes from the lead can be prevented or compensated for. However, for ecological reasons leaded bronzes should be avoided. There are various approaches of sliding layer alloys in the prior art for this purpose. For example, in the case of cast alloys based on brass or bronze, it is hence with the aid of alloying additives such as chromium, manganese, zirconium or aluminum attempted to improve the frictional properties and, in particular, to reduce the tendency towards fretting.

### 2. Description of the Related Art

The use of sulfur in copper alloys has already been described in several publications, such as WO 2010/137483 A1, US2012082588 A1, US 2012/121455 A1, DE 20 2016 101 661 U1 or WO 2007/126006 A1. In this regard, sulfur is predominantly used for improving the machining properties of red brass alloys (CuSnZn matrix). Moreover, these documents report on improved tribological properties. However, the general property of having a wider solidification interval of the mentioned red brass alloys also in combination with further alloying elements impairs several aspects of their use. Especially the casting quality is a problem. The extended solidification interval of e.g. approx. 150° C. in the alloy CuSn7Zn2 causes a pronounced shrinkage porosity, which, especially when used as a casting alloy, results in defects in the material. In case of low tin contents, there additionally is an increased density different between liquid and solid phase, which further intensifies the problem of shrinkage porosity. Even when used as a wrought alloy, the casting porosity can only be partially closed by high degrees of deformation. In both cases, correspondingly increased quality issues, resulting in increased inspection efforts and, as a consequence, in correspondingly higher reject rates are to be expected. The results of subsequent coating processes, such as galvanic coating or polymer coating, which gain increasing significance are also impaired. Such coatings for example gain importance in the use as sliding bearing material particularly where lead-free copper alloys are to replace the current lead bronzes with their outstanding tribological properties.

Moreover, in the use as wrought alloy preferred due to the occurring porosity, these alloys are usually annealed in a recrystallizing manner after the deformation step so as to decrease inner tensions and high material hardness resulting therefrom and/or to increase the low residual formability after deformation. It is known that most solidity-increasing alloying elements and/or the elements which improve corrosion resistance have the disadvantage of driving up the recrystallization temperature. The addition of sulfur indicated for the desired properties of the alloy according to the invention has a comparable effect. At the high annealing temperatures required for this purpose, copper alloys, especially in combination with long treatment times, tend to grain coarsening, which weakens the matrix material. Especially for materials which are characterized by high work hardening, this results in the problem that either grain coarsening occurs, or the recrystallization takes place in an insufficient manner and residual dendrites remain, which have a comparably negative effect on the mechanical properties of the materials as a too coarse structure. Additionally, at high annealing temperatures the solidity of the steel support layer goes down to values of the normally annealed state.

### SUMMARY OF THE INVENTION

It is the object of the invention to provide a sliding bearing element having a lead-free, sulfur-containing cast alloy on a copper basis as further layer, in which the partially negative effects of sulfur on the alloy are reduced.

The object of the invention is solved in the initially mentioned multi-layer sliding bearing element in that the copper base alloy contains between 0.1 wt. % and 3 wt. % sulfur, between 0.01 wt. % and 4 wt. % iron, between 0 wt. %, in particular 0.001 wt. %, and 2 wt. % phosphorus, at least one element from a first group consisting of zinc, tin, aluminum, manganese, nickel, silicon, chromium and indium of in total between 0.1 wt. % and 49 wt. %, wherein the proportion of zinc amounts to between 0 wt. % and 45 wt. %, the proportion of tin amounts to between 0 wt. % and 40 wt. %, the proportion of aluminum amounts to between 0 wt. % and 15 wt. %, the proportion of manganese amounts to between 0 wt. % and 10 wt. %, the proportion of nickel amounts to between 0 wt. % and 10 wt. %, the proportion of silicon amounts to between 0 wt. % and 10 wt. %, the proportion of chromium amounts to between 0 wt. % and 2 wt. %, and the proportion of indium amounts to between 0 wt. % and 10 wt. %, and at least one element from a second group consisting of silver, magnesium, cobalt, titanium, zirconium, arsenic, lithium, yttrium, calcium, vanadium, molybdenum, tungsten, antimony, selenium, tellurium, bismuth, niobium, palladium each to a proportion of between 0 wt. % and 1.5 wt. %, wherein the summary proportion of the elements of the second group amounts to between 0 wt. % and 2 wt. %, and the balance adding up to 100 wt. % being constituted by copper and impurities originating from the production of the elements.

The advantage of this is that the low alloy copper base alloys formed therefrom are characterized by good castability due to the addition of sulfur. Hence, alloys which normally are suitable only to a limited extent can be used in sliding bearings. Furthermore, the copper sulfides formed with the sulfur act as crystal nuclei during solidification and thus have a grain refining effect. Moreover, it is also possible to operate these materials without an additional coating. Furthermore, the workability can be improved since sulfides act as chip breakers. This improved workability results in improved surface quality with lower roughness values and defects. Thereby, consequently, the quality of a plurality of coatings, such as galvanic coatings, PVD or polymer coatings, can be affected positively. In other words, hence, the coatability of the copper base alloy can be improved.

The copper base alloy comprises a combination of sulfur as well as small amounts of iron and phosphorus. Phosphorus is primarily used as a deoxidizing agent in fusion-metallurgy processing of copper materials. A grain refining effect can be achieved by an excess of phosphorus in combination with the addition of iron. Hence, a uniform, fine distribution of the intermetallic phases (predominantly sulfide phases) with copper and the remaining alloying elements can be achieved. By the combination of iron and phosphorus, iron phosphides can emerge already in the melt. As a result, not only can some of the phosphorus harmful for bonding to a steel base body be set, but these intermetallic phases can also be used to reduce the tendency towards grain coarsening in recrystallizing annealing processes, thus improving the mechanical properties of the copper base alloy. Moreover, these iron phosphide phases due to their high hardness can serve to increase heterogeneity of the described copper base alloys, whereby, in turn, the tribological properties can be positively affected.

A decrease of the tendency towards fretting of the lead-free copper base bearing alloys can be achieved by the intermetallic FeS phases, which emerge besides the copper sulfides. The tribological effect of the copper base alloy that can be achieved thereby can be seen in the combination of copper sulfides (predominantly Cu₂S) and iron sulfides (FeS).

By the addition of sulfur to the copper base alloy, the recrystallization temperature of copper can be increased, the susceptibility of copper to the so-called hydrogen brittleness can be reduced, the mechanical workability can be improved by improved chip breakage with the formation of short breaking chips, a wear-inhibiting effect on machining tools and thus their increased tool life and the resulting surface quality can be improved.

By the addition of iron, the distribution of the sulfur precipitates can be improved via a grain refining effect. By the fine distribution and the formation of iron sulfides, tribological properties can be increased. An addition of more than 5 wt. % iron, besides the increase of the liquidus temperature, results in a strong hardening effect as well as a deterioration of the formability. Along with an addition of small amounts of phosphorus, iron phosphide (Fe₂P), which is desired here, as opposed to the one in the bonding zone to the steel, forms directly in the melt. The indicated phase can on the hand limit the grain growth in annealing treatments without having a negative impact on the recrystallization capability per se, which above all considerably simplifies the process control during this heat treatment, on the other hand the inclusion of iron phosphide in the copper matrix has an advantageous impact on the wear resistance of these alloy.

Due to its affinity for oxygen and hydrogen, lithium can be used in copper alloys as a deoxidizer and to remove hydrogen. Thus, lithium can at least mostly replace the amount of phosphorus, whereby the aforementioned problems in composite casting processes, which e.g. connect bearing alloys to a steel base body, can be prevented due to high contents of phosphorus and the brittle phase resulting therefrom. The mentioned brittle phase forms exactly at the bonding zone of the compound material and affects the adhesive strength, depending on its characteristics, up to complete detachment. Lithium as deoxidant does not form any intermetallic phases with iron from the steel base body also in case of higher added amounts. By the use of lithium, the addition of phosphorus can be reduced to a minimum and/or be dispensed with entire, whereby the formation of brittle phases is also omitted and/or small phosphorus contents can be used in a targeted manner. The used lithium can form a liquid slag of low density and thus float up. Hence, the melt can be protected from further access of oxygen and resulting burn-off of alloying elements.

It should be noted at this point that the amounts of lithium used for the deoxidation of the melt are naturally guided by the proportion of oxygen in the melt. The person skilled in the art can thus also add a corresponding excess of lithium if needed in adaption to the actual proportion of oxygen.

In case of the production of a compound corresponding to a sulfur-containing red brass alloy, lithium can be used as a grain refiner in place of zirconium or calcium (which both have a desulfurizing effect). Zirconium does have an effect as a grain refining agent, however, reacts with sulfur which reduces the effect thereof.

By the addition of yttrium, the corrosion resistance of lead-free copper base alloy can be improved. Quantitative proportions of about 0.1 wt. % reduce the weight gain through oxidation by almost 50%. A reduced oxidation tendency can stabilize the bonding of polymer coatings to the bearing material in the operation of a sliding bearing and hence increase the operating safety.

Selenium and/or tellurium can be added to increase the tribologically effective phases.

Indium has a high solubility in copper (>10 wt. %). It forms intermetallic phases and can be used for precipitation hardening. The advantage of indium consists in that after quenching, the bearing material exhibits improved adaptability until the copper base alloy reaches its final hardness through long-term ageing effects at elevated temperatures (e.g. during operation of the plain bearing).

By means of the preferably low tin contents, a high increase in hardness of the copper base alloy can be prevented. In the indicated quantity range, better influence can be exerted on the sulfide distribution in the alloy; with the decrease in tin content, the granular structure of the microstructure is pushed into the background and an alloy is formed, the grains of which emerge with large structures.

By the tin content, a better-defined spherical shape of the deposited sulfides can be achieved.

Silicon in the indicated quantitative proportion can be of advantage with regard to the castability of the alloy and the deoxidation.

Additions of aluminum in the copper base alloy decrease their tendency towards corrosion at high temperatures. In the indicated quantitative proportion, the β solid solution formation is prevented with high certainty.

By means of manganese, the elevated temperature resistance can be increased. Moreover, improved healing of anti-corrosion coatings can be achieved by means of manganese-containing alloys.

Nickel forms nickel sulfides with sulfur, which can generally increase the phase number. Moreover, by means of nickel the corrosion stability of the copper base alloy can be improved. The elastic modulus of a Cu—Ni alloy increases linearly with the addition of nickel.

By means of chromium, the recrystallization temperature and the elevated temperature resistance of the copper base alloy can be improved.

According to a preferred embodiment variant of the multi-layer sliding bearing element, it can be provided for that the copper base alloy of the further layer contains either zinc or tin. By avoiding the combination of both elements in the copper base alloy, a significant improvement of the casting properties of the alloy can be achieved by the decrease of the solidification interval of the copper base alloy achieved thereby.

For further improvement of the properties of the copper base alloy described above, at least one of the following embodiment variants of the invention can be provided for:
the summary proportion of the elements from the first group consisting of zinc, tin, aluminum, manganese, nickel, silicon, chromium amounts to between 0.5 wt. % and 15 wt. %, and/or
the copper base alloy of the further layer contains between 0.01 wt. % and 5 wt. % zinc, and/or
the copper base alloy of the further layer contains between 0.01 wt. % and 10 wt. % tin, and/or
the copper base alloy of the further layer contains between 0.01 wt. % and 7.5 wt. % aluminum, and/or
the copper base alloy of the further layer contains between 0.01 wt. % and 5 wt. % manganese, and/or
the copper base alloy of the further layer contains between 0.01 wt. % and 5 wt. %, in particular between 0.01 wt. % and 2 wt. % nickel, and/or
the copper base alloy of the further layer contains between 0.01 wt. % and 7 wt. %, in particular between 0.01 wt. % and 3 wt. % silicon, and/or
the copper base alloy of the further layer contains between 0.01 wt. % and 1.5 wt. %, in particular between 0.01 wt. % and 1 wt. % chromium, and/or
the copper base alloy of the further layer contains between 0.3 wt. % and 0.8 wt. % sulfur, and/or
the copper base alloy of the further layer contains between 0.01 wt. % and 0.1 wt. % phosphorus, and/or
the copper base alloy of the further layer contains between 0.3 wt. % and 1.5 wt. % iron.

According to another embodiment variant of the multi-layer sliding bearing element, it can also be provided for that the copper base alloy of the further layer additionally contains between 0.001 wt. % and 1.5 wt. %, in particular between 0.001 wt. % and 1 wt. %, boron. Hence, it is possible to obtain a denser structure of the grain boundaries. The copper alloy thus has an improved solidity (increased grain boundary solidity) and ductility. Moreover, the alloy has a reduced cracking risk, whereby the structure in the further layer has more fracture toughness. In addition to this, boron can also have a positive effect with respect to the deoxidation of the melt and, optionally along with iron, act as a grain refiner.

According to a further embodiment variant, it can be provided for that the sulfide precipitates are present being homogeneously distributed within the entire further layer, such that the further layer thus has essentially the same properties over the entire cross section.

However, according to another embodiment variant of the multi-layer sliding bearing element, it can also be provided for that the sulfide precipitates are formed merely within a partial layer of the copper base alloy of the further layer. Hence, the further layer itself can be provided with a broader spectrum of properties such that, optionally, the multi-layer sliding bearing element can be built up in a simpler manner by reduction of the number of layers.

According to an embodiment variant in this regard, it can be provided for that the partial layer comprises a layer thickness amounting to between 5% and 85% of the total layer thickness of the further layer. If the share of the partial layer in the layer thickness is less than 5% of the total layer thickness, the further layer can no longer fulfill its task as a further layer of the multi-layer plain bearing element, in particular as a sliding layer, to the desired extent. However, it can then still have the properties of a running-in layer. In case of a layer thickness of more than 85% of the total layer thickness, in contrast, the effort for the formation of partial layer is higher than the gain that can be achieved by reducing the number of individual layers.

The added sulfur reacts with other components of the copper base alloy to form sulfides. In this regard, according to another embodiment variant of the invention it can be provided for that the sulfide precipitates consist of a mixture of copper sulfides and iron sulfides to at least 50 area-%. Hence, the self-lubrication behavior of the copper base alloy can be improved.

For further improvement of this effect, according to a further embodiment variant of the multi-layer sliding bearing element, it can be provided for that the proportion of copper sulfides in the mixture of copper sulfides and iron sulfides amounts to at least 60 area-%.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 a side view of a multi-layer sliding bearing element;

FIG. 2 a cutout from the sliding layer of an embodiment variant of the multilayer sliding bearing element in a sectional side view;

FIG. 3 a cutout from the sliding layer of another embodiment variant of the multi-layer sliding bearing element in a sectional side view;

FIG. 4 a cutout from the sliding layer of a further embodiment variant of the multi-layer sliding bearing element in a sectional side view; and

FIG. 5 a cutout from the sliding layer of an embodiment variant of the multilayer sliding bearing element in a sectional side view.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

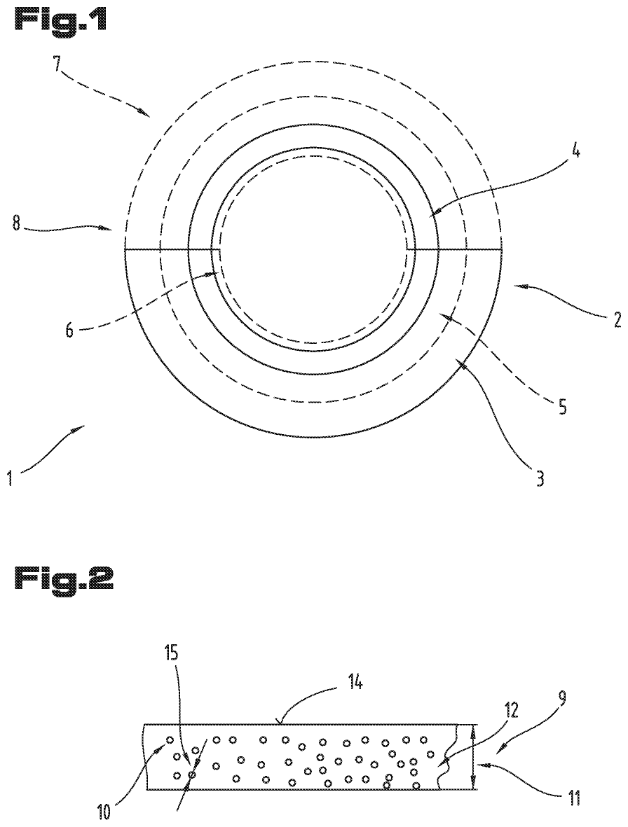

FIG. 1 shows a multi-layer sliding bearing element 1, in particular a radial sliding bearing element, made from a composite material in a side view.

The multi-layer sliding bearing element 1 is provided in particular for use in a combustion engine or for bearing of a shaft. However, it can also be used for other applications, for example in wind turbines, in particular wind turbine gearboxes, e.g. on a or as a coating of a planetary gear bolt in the region of the bearing of a planetary gear, as inner coating of a gear (also for bearing the gear), as industry sliding bearing in compressors, steam and gas turbines, or as a part of a sliding bearing for a rail vehicle, etc.

The multi-layer sliding bearing element 1 comprises a sliding bearing element body 2. The sliding bearing element body 2 comprises a supporting metal layer 3 and a further layer 4 arranged thereon and/or consists of the supporting metal layer 3 and the further layer 4 connected thereto.

As is adumbrated is dashed lines in FIG. 1, the sliding bearing element body 2 can also comprise one or several additional layer(s), for example a bearing metal layer 5, which is arranged between the further layer 4 and the supporting metal layer 3, and/or a running-in layer 6 on the further layer 4. At least one diffusion barrier layer and/or at least one bonding layer can also be arranged between at least two of the layers of the multi-layer sliding bearing element 1.

Since the basic structure of such multi-layer sliding bearing element 1 is known from the prior art, reference is made to relevant literature with regard to the details of the structure of the layers.

Likewise, the used materials which the supporting metal layer 3, the bearing metal layer 5, the running-in layer 6, the at least one diffusion barrier layer and the at least one bonding layer can consist of are known from the prior art, and reference is thus made to relevant literature with respect to these. By way of example, it should be noted that the supporting metal layer 3 can be formed of a steel, the bearing metal layer 5 can be formed of a copper alloy with 5 wt. % tin and the balance copper, the running-in layer can be formed of tin, lead, or bismuth or from a synthetic polymer or a PCD coating, containing at least one additive, the diffusion barrier layer can for example be formed of copper or nickel.

The half-shell-shaped multi-layer sliding bearing element 1 forms a sliding bearing 8 along with at least one further sliding bearing element 7—depending on the construction it is also possible that there is more than one further sliding bearing element 7. In this regard, it is preferred that the lower sliding bearing element is formed by the multi-layer sliding bearing element 1 according to the invention in the built-in state. However, it is also possible that at least one of the at least one further sliding bearing elements 7 is formed by the multi-layer sliding bearing element 1 or that the entire sliding bearing 8 is formed by at least two multi-layer sliding bearing element 1 according to the invention.

Furthermore, it is possible that the sliding bearing element 1 is formed as sliding bearing bush, as is adumbrated in dashed lines in FIG. 1. In this case, the multi-layer sliding bearing element 1 at the same time is the sliding bearing 8.

Moreover, it is possible that the further layer 4 forms a direct coating, for example a radially inner coating of a connecting rod eye, wherein, in this case, the component to be coated, i.e. for example the connecting rod, forms the supporting metal layer 3.

Furthermore, the multi-layer sliding bearing element 1 and/or the sliding bearing 8 can also be designed in the form of a collar bearing, etc.

The further layer 4 is particularly formed as a sliding layer 9. In this regard, FIG. 2 shows a first embodiment variant of the sliding layer 9.

The sliding layer 9 consists of a cast alloy of a copper base alloy.

The copper base alloy, besides copper, sulfur, iron, phosphorus, comprises at least one element from a first group consisting of zinc, tin, aluminum, manganese, nickel, silicon, chromium and indium of between 0.1 wt. % and 49 wt. % in total %, and at least one element from a second group consisting of silver, magnesium, cobalt, titanium, zirconium, arsenic, lithium, yttrium, calcium, vanadium, molybdenum, tungsten, antimony, selenium, tellurium, bismuth, niobium, palladium, wherein the summary proportion of the elements of the second group amounts to between 0 wt. % and 2 wt. %.

Optionally, the copper base alloy of the further layer 4 can additionally contain boron.

The copper base alloy is lead-free, wherein lead-free means that lead can be contained to an extent of 0.1 wt. % at maximum.

Since the primary effects of the individual elements in copper base alloys are known from the prior art, reference is made thereto in this respect. Moreover, reference is made to the statements regarding the effects of the alloying elements made above.

The possible proportions of the individual elements to the copper base alloy are summarized in Table 1. The indications of percentages regarding the proportions in Table 1, as in the entire description, are to be understood as wt. % unless explicitly stated otherwise.

In each copper base alloy, apart from unavoidable impurities, copper forms the balance adding up to 100 wt. %.

TABLE 1
Quantity ranges of the alloying elements of the copper base alloy

| | range | preferred range | particularly preferred |
|---|---|---|---|
| element | [wt. %] | [wt. %] | range [wt. %] |
| S | 0.1-3 | 0.2-1.5 | 0.3-0.8 |
| Fe | 0.01-4 | 0.2-2 | 0.3-1.5 |
| P | 0.001-2 | 0.01-0.5 | 0.02-0.1 |
| Sn | 0-40 | 0.001-25 | 0.01-10 |
| Zn | 0-45 | 0.001-9 | 0.01-5 |
| Al | 0-15 | 0.001-10 | 0.01-7.5 |
| Mn | 0-10 | 0.001-7.5 | 0.01-5 |
| Ni | 0-10 | 0.01-5 | 0.01-2 |
| Si | 0-10 | 0.01-7 | 0.01-3 |
| Cr | 0-2 | 0.01-1.5 | 0.01-1 |
| In | 0-10 | 0.01-7 | 0.01-3 |
| Ag | 0-1.5 | 0.001-1 | 0.001-0.1 |
| Mg | 0-1.5 | 0.001-1 | 0.001-0.1 |
| Co | 0-1.5 | 0.001-1 | 0.001-0.1 |
| Ti | 0-1.5 | 0.001-1 | 0.001-0.1 |
| Zr | 0-1.5 | 0.001-1 | 0.001-0.1 |
| As | 0-1.5 | 0.001-1 | 0.001-0.1 |
| Li | 0-1.5 | 0.001-1 | 0.001-0.1 |
| Y | 0-1.5 | 0.001-1 | 0.001-0.1 |
| Ca | 0-1.5 | 0.001-1 | 0.001-0.1 |
| V | 0-1.5 | 0.001-1 | 0.001-0.1 |
| Mo | 0-1.5 | 0.001-1 | 0.001-0.1 |
| W | 0-1.5 | 0.001-1 | 0.001-0.1 |
| Sb | 0-1.5 | 0.001-1 | 0.001-0.1 |
| Se | 0-1.5 | 0.001-1 | 0.001-0.1 |
| Te | 0-1.5 | 0.001-1 | 0.001-0.1 |
| Bi | 0-1.5 | 0.001-1 | 0.001-0.1 |
| B | 0-1.5 | 0.001-1 | 0-impurity |
| Niobium | 0-1.5 | 0.001-1 | 0.001-0.1 |
| Palladium | 0-1.5 | 0.001-1 | 0.001-0.1 |

The indications of the quantitative ranges in Table 1 are to be understood such that they also address the respective marginal and intermediate ranges. For example, the proportion of S can amount to 0.1-3, 0.2-1.5, 0.3-0.8, 0.1-0.2, 0.1-1.5, 0.1-0.3, 0.1-0.8, 0.2-0.3, 0.2-0.8, 0.3-3, 0.3-1.5, 0.8-3 and 0.8-1.5, each in wt. %. This correspondingly applies to the other elements in Table 1.

The summary proportion of the elements from the first group comprising or consisting of zinc, tin, aluminum, manganese, nickel, silicon, chromium preferably amounts to a maximum of 7 wt. %, in particular a maximum of 5 wt. %. For example, the summery proportion of the elements from the first group can also amount to between 0.5 wt. % and 15 wt. %.

It is furthermore preferred if tin and zinc are not contained in the copper base alloy together; i.e. if it contains either tin or zinc.

As can be seen from FIG. 2, sulfide precipitates 10 are contained in the sliding layer 9. These sulfide precipitates 10 emerged by reaction of at least one metallic component of the alloy of the copper base alloy with the sulfur. Mixed sulfides are also possible.

As can be seen from the method elucidated below, the sulfide precipitates 10 of the copper base alloy are not added as such, although this is possible within the framework of the invention, but these precipitates 10 are generated from at least one component of the alloy as a consequence of a redox reaction in the melt during the production of the alloy.

The proportion of the sulfide precipitates 10 in the copper base alloy preferably amounts to between 1 area-% and 20 area-% in particular between 2 area-% and 15 area-%. In case of a proportion of more than 24 area-%, there is a risk of the contained sulfur having a negative effect at the grain boundaries. In case of a proportion of less than 1 area-%, effects are still observed, but only to an unsatisfactory extent. In this regard, the indication area-% refers to the total area of a longitudinal micrograph of the sliding layer 9 in each case.

The sliding layer 9 has a total layer thickness 11. The total layer thickness 11 particularly amounts to between 100 μm and 2500 μm, preferably between 150 μm and 700 μm.

As can be seen from FIG. 2, the sulfide precipitates 10 are preferably homogeneously distributed across the entire total layer thickness 11 of the sliding layer 9 and thus in the entire sliding layer 9, i.e. its entire volume, in this embodiment variant.

In this regard, the term “homogeneously” means that the difference in the number of sulfide precipitates 10 of two different volume areas of the sliding layer 9 in each case does not deviate from one another by more than 12%, in particular not by more than 9%, wherein the reference value with 100% is a number of sulfide precipitates 10 in a volume area of the sliding layer 9, which is calculated by the total number of precipitates 10 in the total volume of the sliding layer 9 divided by the number of the volume areas which the total volume comprises.

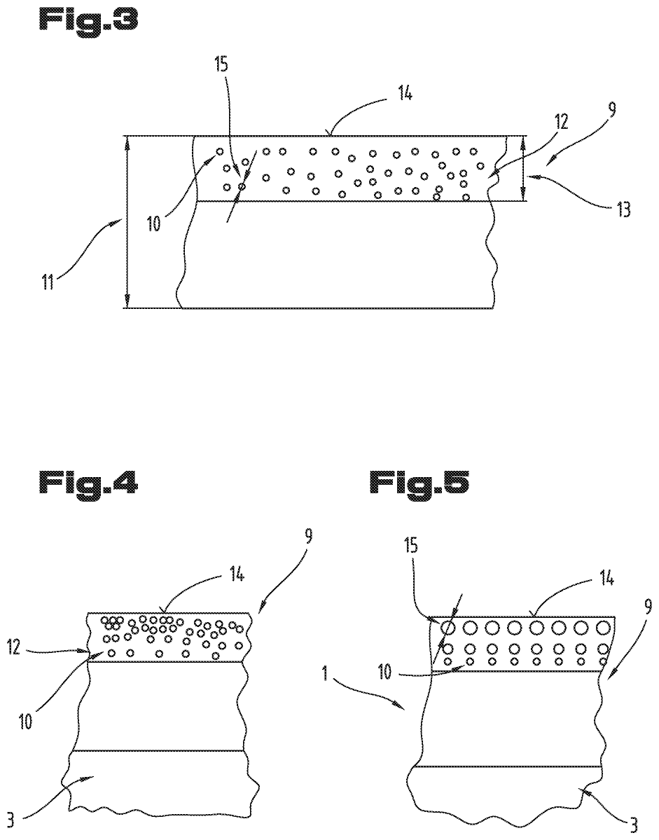

However, it is also possible that the arrangement and/or formation of the sulfide precipitates 10 is limited to merely one area within the partial layer 12 of the sliding layer 9, as can be seen from FIG. 3. In this regard, the sulfide precipitates 10 are arranged within, in particular exclusively within, this partial layer 12. Within this partial layer 12 the sulfide precipitates 10 are preferably again distributed homogeneously, wherein the term “homogeneously” is to be understood within the meaning of the above definition, in which “sliding layer” is replaced by “partial layer”.

According to an embodiment variant in this regard, it can be provided for that the partial layer 12 has a layer thickness 13 amounting to between 5% and 85%, in particular between 10% and 50%, of the total layer thickness 11 of the further layer 4, i.e. in this exemplary embodiment of the sliding layer 9.

The partial layer 12 is preferably formed on one side of the sliding layer 9 and thus preferably forms a surface 14, in particular a sliding surface, of the multilayer sliding bearing element 1.

However, it is also possible that the number of sulfide precipitates 10 in the direction of the surface 14 of the copper base alloy of the sliding layer 9 gradually decreases towards the supporting metal layer 3, as is represented in FIG. 4 for the partial layer 12. Such a gradient can also be entirely formed in the sliding layer 9, i.e. not only in the partial layer 12. In this regard, sulfide precipitates 10 are present in the entire volume of the sliding layer 9 within the meaning of FIG. 2.

It should be noted that the figures each show optionally independent embodiments of the multi-layer sliding bearing element 1, wherein equal reference numbers and/or component designations are used for equal parts. In order to avoid unnecessary repetitions, it is pointed to/reference is made to the detailed description regarding all figures in each case.

By the reduction of the number of sulfide precipitates 10 in the sliding layer 9 and/or the partial layer 12 of the sliding layer 9 in the direction towards the supporting metal layer 3, a hardness gradient can be set in the sliding layer 9.

It is also possible that the number of sulfide precipitates 10 in the sliding layer 9 and/or in the partial layer 12 of the sliding layer 9 in the direction of the surface 14 of the copper base alloy of the sliding layer 9 gradually increases and/or in general varies towards the supporting metal layer 3.

In general, the sulfide precipitates 10 can have a maximum particle diameter 15 (FIGS. 2 and 3) of a maximum of 60 μm, in particular between 0.1 μm and 30 μm. Preferably, the maximum particle diameter 15 amounts to between 10 μm and 25 μm. In this regard, the maximum particle diameter 15 is understood as the largest dimension a particle has.

The grain size of the remaining structure can amount to between 2 μm and 500 μm, in particular between 2 μm and 40 μm. In this regard, large grain sizes preferably occur only at the bonding zone of the sliding layer 9 to the layer arranged immediately thereunder of the multi-layer sliding bearing element 1. In the special case of a dendritic cast structure, the grain size can also correspond to the total layer thickness.

In this regard, it is possible that the particle diameter 15 of the sulfide precipitates 10 essentially remains constant over the entire volume of the sliding layer 9, meaning that the maximum particle diameters 15 of the precipitates 10 do not differ by more than 20%, in particular not by more than 15%.

On the other hand, according to a further embodiment variant of the multilayer sliding bearing element 1, as shown in FIG. 5, it is possible that the sulfide precipitates 10 have a maximum particle diameter 15 that gradually decreases in the direction of the surface 14 of the copper base alloy towards the supporting metal layer 3. In this regard, the particle diameter 15 of the sulfide precipitates 10 can decrease by a value selected from a range of 0.1% to 80%, in particular from a range of 0.1% to 70%, with respect to the particle diameter 15 of the precipitates 10 in the region of the surface 14.

However, it is also possible that the sulfide precipitates 10 have a maximum particle diameter 15 that gradually increases and/or generally varies in the direction of the surface 14 of the copper base alloy towards the supporting metal layer 3. In this regard, the particle diameter 15 of the sulfide precipitates 10 can increase by a value selected from a range of 0.1% to 80%, in particular from a range of 0.1% to 70%, with respect to the particle diameter 15 of the sulfide precipitates 10 in the region of the surface 14.

The habitus of the sulfide precipitates 10 may be at least approximately spherical, at least approximately ellipsoidal and/or ovoid, bulbous, stem-shaped (i.e. elongated), at least approximately cubic, etc., or completely irregular. Preferably, the sulfide precipitates 10 are at least approximately round and/or at least approximately spherical and/or at least approximately ellipsoidal.

As already mentioned, the precipitates 10 are of sulfidic nature. The sulfide precipitates 10 can mainly consist of copper sulfides and/or iron sulfides. The proportion of this mixture in the total proportion of the sulfides amounts to at least 50 area-%, in particular at least 70 area-%, preferably at least 80 area-%. Besides these sulfides, there also are other sulfides, for example zinc sulfides, in the copper base alloy, as was already described above.

The zinc sulfide can be formed within at least one discrete region in a copper sulfide particle. Between one and five such discrete regions can be formed within the copper sulfide particles. In other words, the zinc sulfide can be contained in the copper sulfide particles in an inhomogeneously distributed manner.

The alloy can also contain a mixture of copper sulfides and iron sulfides. Within this mixture of copper sulfides and iron sulfides, the proportion of copper sulfides can amount to at least 60 area-%, in particular at least 75 area-%.

In order to achieve a distribution of sulfide phases (sulfide precipitates 10) in the further layer 4 that is as fine as possible, which better uses the effect of the addition of sulfur, a fine matrix structure should be formed. This can on the one hand be achieved via high cooling rates, on the other hand via metallurgical grain refining.

In sulfur-containing alloy, it became apparent that many of the grain refining alloying elements additionally have a high affinity towards sulfur and tend to form undesirable compounds with this element, which then slag. In the case of the copper alloy, particularly zirconium is to be mentioned, which can act as a very good grain refiner; however, also has a highly desulfurizing effect. A further element for grain refining in copper is e.g. calcium; however, its desulfurizing effect is known from the steel industry. In general, this can be counteracted by the sulfur proportion, the temperature control, the time of addition of the desulfurization.

Most grain refiners known for copper alloys have a high oxygen affinity and would thus react with oxygen present in the non-deoxidized melt and lose their effect.

The addition of phosphorus as a deoxidant in the form of phosphorus copper for deoxidisation of copper alloys is known. By the deoxidisation, inter alia the flow properties of the melt are improved; additionally, the alloyed sulfur is protected from burning off with oxygen in the melt. As already mentioned, a too high remaining content of phosphorus in compound casting increases the risk of brittle phase formation (iron phosphide) in the bonding zone. The correct quantity to be added can be calculated based on the oxygen activity of the current melt via the stoichiometric conditions. However, measurement of the activity in the used alloys is only possible with measuring heads that can be used once only and is always subject to measurement uncertainty. In case of the low amounts of melt of less than 100 kg, such a measurement is not economical. Moreover, the input of oxygen and hydrogen by the measurement itself is a significant disadvantage.

The use of lithium in the mentioned copper alloys entails several advantages. Lithium has an excellent deoxidizing effect. The thus achieved residual oxygen contents hence protect the alloying element sulfur and other elements having an affinity for oxygen from burn-off. Besides the removal of oxygen, lithium also has the property of forming compounds with hydrogen (LiH, LiOH). Hence, the addition of lithium also results in a decrease of the hydrogen content in the melt. Lithium is capable of forming a liquid slag above the melt with its reaction partners and thus prevents a further entry of oxygen and hydrogen into the melt. Moreover, lithium per se has a grain-refining effect and thus also ensures fine distribution of the sulfides in the material.

For producing the multi-layer sliding bearing element 1, in a first step, a primary material comprising at least two layers can be produced. For this purpose, in the simplest case, the copper base alloy can be cast onto a, particularly planar, metal strip or a, particularly planar, sheet metal.

In this regard, the metal strip or the sheet metal forms the supporting metal layer 3. If planar metal strips or sheet metals are used, these are formed into the respective multi-layer sliding bearing element 1 in a later method step, as is per se known from the prior art.

As stated above, the multi-layer sliding bearing element 1 can also comprise more than two layers. In this case, the copper base alloy can be cast onto the respective uppermost layer of the composite material with the supporting metal layer 3, or a further, in particular two-layer, composite material is first produced, which is then connected to the supporting metal layer 3 or to a composite material comprising the supporting metal layer 3, for example by roll cladding, if necessary with the interposition of a bonding foil.

Casting of the copper base alloy onto the metal strip and/or the sheet metal or onto a layer of a composite material can for example be carried out by means of horizontal tape casting.

However, it is also possible that a copper base alloy is produced for example by means of continuous casting or ingot casting in a first step and the solidified copper base alloy is only subsequently connected to at least one of the further layers of the multi-layer sliding bearing element 1, in particular the supporting metal layer 3, for example by means of roll cladding.

According to another embodiment variant, it is possible that the multi-layer sliding bearing element 1 is produced in a centrifugal casting method or according to a gravity casting method.

Direct coatings of components, such as connecting rod eyes, are also possible. Moreover, powder coating methods can also be applied.

The copper base alloy can also be applied onto the respective subjacent layer of the multi-layer sliding bearing element 1 or the component according to a sintering method.

The proportions of the components in the starting mixture used for the production of the sliding layer 9 are selected according to the indications in Table 1.

In principle, the casting of alloys from the melt is known to the person skilled in the art relating to sliding bearings, such that with regard to the parameters, such as temperature, etc., reference is made to the relevant prior art. Casting of the alloy is preferably carried out under an inert gas atmosphere.

Preferably, cooling of the solidified melt is carried out with oil up to a temperature of approximately 300° C. and then with water and/or air to at least approximately ambient temperature. However, cooling can also be carried out differently. Preferably, forced cooling of the alloy or composite material is carried out as after casting.

After the deformation that is optionally carried out, for example into a half-shell shape, as well as optionally final processing, such as fine boring, coating, etc., the multi-layer sliding bearing element 1 is finished. These final processing steps are known to the person skilled in the art relating to sliding bearings, such that reference is made to relevant literature in this regard.

According to an embodiment variant of the method, the copper base alloy is deformed after casting, in particular rolled, wherein a deformation degree of a maximum of 80%, in particular between 20% and 80% is applied.

After the deformation, in particular rolling, the copper base alloy can be subjected to a heat treatment. The latter can generally be carried out at a temperature of between 200° C. and 700° C. The heat treatment can be carried out in a reducing atmosphere, for example under a forming gas. Moreover, the heat treatment can be carried out for a period of time from 2 hours to 20 hours. Due to the fine iron phosphide particles present in the layer 4, no strong grain coarsening occurs during the heat treatment.

Besides the formation of the further layer 4 as sliding layer 9, it can also form another layer in the multi-layer sliding bearing element 1, for example a bearing metal layer, which is arranged between a sliding layer and a supporting metal layer, or a running-in layer, which is arranged on a sliding layer.

Below, some of the tests carried out are described.

In general, the compositions for the copper base alloy indicated in Table 2 were produced according to the following method.

The copper base alloy was cast onto a supporting metal layer 3 from a steel with the dimensions 220 mm width and 4 mm thickness by means of tape casting. In this regard, the preheated steel had a temperature of 1070° C. and a speed of 2.5 m/min. The cast alloy is cast onto it with a temperature of approx. 1130° C. The steel is cooled by means of oil cooling from below to approx. 350° C. and subsequently further cooled with water, such that the cast alloy solidifies in the compound. This compound was subjected to a thickness reduction of 40% by rolling. Subsequently, this material was heat-treated under an inert gas atmosphere at 525° C. for 7 hours and subsequently deformed into the half-shell shape.

Depending on the alloy composition, the heat treatment of the material can for example also be carried out at 450° C., in particular 500° C., for ten hours to 630° C., in particular 610° C., for six hours.

Thus, two-layer sliding bearing elements in half-shell shape with a layer thickness of the sliding layer 9 of less than 1 mm were created.

With regard to Table 2 below, reference is made to the fact that, again, all indications regarding the composition are to be understood in wt. %, and that the balance adding up to 100 wt. % is constituted by copper. Usual production-related impurities of the metals are not indicated separately. These are merely exemplary embodiments in the context of the quantity ranges for the individual alloy components indicated in Table 1 above. If for individual components and/or elements of the copper base alloy the entire range indicated in Table 1 is not covered by examples, this does not imply a restriction to the punctual proportions shown in Table 2 for this element. The indications of quantity regarding the elements in Table 2 are the ones that were used for the production of the copper base alloy.

Regarding alloys with alloying elements from the second group, two “base alloys” only were used in each case. However, this does not means that the addition of these elements is limited to the indicated composition of these “base alloys”.

Moreover, only one of the alloying elements from the second group of the “base alloy” was alloyed. However, it is self-evident that compositions with more than one of these alloying elements from the second group are also possible within the framework of the invention.

TABLE 2
Exemplary compositions for copper base alloys.

| No. | S | Fe | P | Zn | Sn | Al | Mn | Ni | Si | Cr | In | others | |
|---|---|---|---|---|---|---|---|---|---|---|---|---|---|
| 1 | 0.1 | 0.2 | 0.01 | 45 | | 7.5 | 0.01 | 1.9 | | | | | |
| 2 | 3 | 3.8 | 2 | 9 | 15 | 0.001 | 7.5 | | 2.76 | 0.001 | | | |
| 3 | 0.3 | 1.5 | 0.5 | | 40 | 4.5 | 0.75 | | | 1.5 | 0.01 | | |
| 4 | 1.5 | 2 | 0.45 | 5 | | | | | 4.9 | 2 | 9.8 | | |
| 5 | 0.8 | 1.1 | 0.1 | 3.5 | | 10 | 1.25 | 4.5 | | 0.45 | | | |
| 6 | 0.1 | 0.01 | 0.001 | | 25 | | | | | | 0.01 | | |
| 7 | 3 | 4 | 2 | | | 15 | | | | | 10 | | |
| 8 | 0.3 | 0.35 | 0.5 | | 10 | | 9.1 | | | | 0.001 | | |
| 9 | 1.5 | 1.8 | 0.45 | | 12.1 | | | 10 | | | 7 | | |
| 10 | 0.8 | 1.5 | 0.01 | 0.35 | 0.5 | | | | 7 | 0.2 | 3 | | |
| 11 | 0.21 | 1 | 0.01 | 12 | | 3.2 | 2.5 | 1.5 | | | | | |
| 12 | 2.8 | 0.25 | 0.1 | | | 15 | 5 | | 3.8 | 0.65 | | | |
| 13 | 0.3 | 0.54 | 0.25 | | | | 7.4 | 2 | | | 10 | | |
| 14 | 1.2 | 1.2 | 0.55 | | | 8.7 | | 1.8 | 0.05 | 1.2 | 6.5 | | |
| 15 | 0.6 | 1.8 | 0.76 | | | | | | | | 0.01 | | |
| 16 | 0.4 | 0.7 | 0.02 | 1.2 | 2 | 5.5 | 2.3 | 0.03 | 0.03 | 0.03 | | | |
| 17 | 2.7 | 3.1 | 1.9 | 45 | | | | | | | | | |
| 18 | 2.7 | 1.6 | 0.6 | | 40 | | | | | | | | |
| 19 | 1.5 | 0.05 | 0.45 | | | | | | | | 8.8 | | |
| 20 | 0.75 | 0.45 | 0.09 | | | 7.7 | | | | | | | |
| 21 | 0.1 | 0.2 | 0.005 | | | | 10 | | | | | | |
| 22 | 2 | 2.9 | 2 | | | | | 5 | | | | | |
| 23 | 1.11 | 2.7 | 0.8 | | | | | | 4.4 | | | | |
| 24 | 0.7 | 0.9 | 0.44 | | | | | | | 1 | | | |
| 25 | 0.8 | 0.3 | 0.1 | 12.1 | | 4.1 | | 9.8 | | | 7.5 | | |
| 26 | 0.7 | 0.25 | 0.01 | 30 | | | | | 1 | | | | |
| 27 | 1.33 | 1 | 0.45 | | 5 | | | | | | | | |
| 28 | 0.8 | 0.54 | 0.1 | 11.5 | | | | | 1.1 | | | | |
| 29 | 0.1 | 1.2 | 0.001 | 8 | 3.3 | | | | | | | | |
| 30 | 1.2 | 1.5 | 0.2 | | 5.8 | | | | 6.2 | | | | |
| 31 | 0.6 | 0.35 | 0.01 | | | | | 1.9 | 2 | | | | |
| 32 | 1.21 | 1.8 | 0.01 | 35 | | 1 | 2.2 | | 0.9 | | | | |
| 33 | 1.6 | 0.1 | 0.1 | | 4 | | | 2.2 | | | | | |
| 34 | 0.7 | 1.5 | 0.1 | 5 | | 1.8 | 5 | 0.01 | 0.2 | 0.01 | 7 | Ag | 1.5 |
| 35 | 0.8 | 1.5 | 0.1 | | 10 | 4.35 | 7 | | 2.8 | 1.2 | 3 | Ag | 1.5 |
| 36 | 0.8 | 1.5 | 0.1 | 5 | | 1.8 | 5 | 0.01 | 0.2 | 0.01 | 7 | Ag | 1 |
| 37 | 0.8 | 1.5 | 0.1 | | 10 | 4.35 | 7 | | 2.8 | 1.2 | 3 | Ag | 1 |
| 38 | 0.8 | 1.5 | 0.1 | 5 | | 1.8 | 5 | 0.01 | 0.2 | 0.01 | 7 | Ag | 0.1 |
| 39 | 0.8 | 1.5 | 0.1 | | 10 | 4.35 | 7 | | 2.8 | 1.2 | 3 | Ag | 0.1 |
| 40 | 0.8 | 1.5 | 0.1 | 5 | | 1.8 | 5 | 0.01 | 0.2 | 0.01 | 7 | Ag | 0.001 |
| 41 | 0.8 | 1.5 | 0.1 | | 10 | 4.35 | 7 | | 2.8 | 1.2 | 3 | Ag | 0.001 |
| 42 | 0.8 | 1.5 | 0.1 | 5 | | 1.8 | 5 | 0.01 | 0.2 | 0.01 | 7 | Mg | 1.5 |
| 43 | 0.8 | 1.5 | 0.1 | | 10 | 4.35 | 7 | | 2.8 | 1.2 | 3 | Mg | 1.5 |
| 44 | 0.8 | 1.5 | 0.1 | 5 | | 1.8 | 5 | 0.01 | 0.2 | 0.01 | 7 | Mg | 1 |
| 45 | 0.8 | 1.5 | 0.1 | | 10 | 4.35 | 7 | | 2.8 | 1.2 | 3 | Mg | 1 |
| 46 | 0.8 | 1.5 | 0.1 | 5 | | 1.8 | 5 | 0.01 | 0.2 | 0.01 | 7 | Mg | 0.1 |
| 47 | 0.8 | 1.5 | 0.1 | | 10 | 4.35 | 7 | | 2.8 | 1.2 | 3 | Mg | 0.1 |
| 48 | 0.8 | 1.5 | 0.1 | 5 | | 1.8 | 5 | 0.01 | 0.2 | 0.01 | 7 | Mg | 0.001 |
| 49 | 0.8 | 1.5 | 0.1 | | 10 | 4.35 | 7 | | 2.8 | 1.2 | 3 | Mg | 0.001 |
| 50 | 0.8 | 1.5 | 0.1 | 5 | | 1.8 | 5 | 0.01 | 0.2 | 0.01 | 7 | Co | 1.5 |
| 51 | 0.8 | 1.5 | 0.1 | | 10 | 4.35 | 7 | | 2.8 | 1.2 | 3 | Co | 1.5 |
| 52 | 0.8 | 1.5 | 0.1 | 5 | | 1.8 | 5 | 0.01 | 0.2 | 0.01 | 7 | Co | 1 |
| 53 | 0.8 | 1.5 | 0.1 | | 10 | 4.35 | 7 | | 2.8 | 1.2 | 3 | Co | 1 |
| 54 | 0.8 | 1.5 | 0.1 | 5 | | 1.8 | 5 | 0.01 | 0.2 | 0.01 | 7 | Co | 0.1 |
| 55 | 0.8 | 1.5 | 0.1 | | 10 | 4.35 | 7 | | 2.8 | 1.2 | 3 | Co | 0.1 |
| 56 | 0.8 | 1.5 | 0.1 | 5 | | 1.8 | 5 | 0.01 | 0.2 | 0.01 | 7 | Co | 0.001 |
| 57 | 0.8 | 1.5 | 0.1 | | 10 | 4.35 | 7 | | 2.8 | 1.2 | 3 | Co | 0.001 |
| 58 | 0.8 | 1.5 | 0.1 | 5 | | 1.8 | 5 | 0.01 | 0.2 | 0.01 | 7 | Ti | 1.5 |
| 59 | 0.8 | 1.5 | 0.1 | | 10 | 4.35 | 7 | | 2.8 | 1.2 | 3 | Ti | 1.5 |
| 60 | 0.8 | 1.5 | 0.1 | 5 | | 1.8 | 5 | 0.01 | 0.2 | 0.01 | 7 | Ti | 1 |
| 61 | 0.8 | 1.5 | 0.1 | | 10 | 4.35 | 7 | | 2.8 | 1.2 | 3 | Ti | 1 |
| 62 | 0.8 | 1.5 | 0.1 | 5 | | 1.8 | 5 | 0.01 | 0.2 | 0.01 | 7 | Ti | 0.1 |
| 63 | 0.8 | 1.5 | 0.1 | | 10 | 4.35 | 7 | | 2.8 | 1.2 | 3 | Ti | 0.1 |
| 64 | 0.8 | 1.5 | 0.1 | 5 | | 1.8 | 5 | 0.01 | 0.2 | 0.01 | 7 | Ti | 0.001 |
| 65 | 0.8 | 1.5 | 0.1 | | 10 | 4.35 | 7 | | 2.8 | 1.2 | 3 | Ti | 0.001 |
| 66 | 0.8 | 1.5 | 0.1 | 5 | | 1.8 | 5 | 0.01 | 0.2 | 0.01 | 7 | Zr | 1.5 |
| 67 | 0.8 | 1.5 | 0.1 | | 10 | 4.35 | 7 | | 2.8 | 1.2 | 3 | Zr | 1.5 |
| 68 | 0.8 | 1.5 | 0.1 | 5 | | 1.8 | 5 | 0.01 | 0.2 | 0.01 | 7 | Zr | 1 |
| 69 | 0.8 | 1.5 | 0.1 | | 10 | 4.35 | 7 | | 2.8 | 1.2 | 3 | Zr | 1 |
| 70 | 0.8 | 1.5 | 0.1 | 5 | | 1.8 | 5 | 0.01 | 0.2 | 0.01 | 7 | Zr | 0.1 |
| 71 | 0.8 | 1.5 | 0.1 | | 10 | 4.35 | 7 | | 2.8 | 1.2 | 3 | Zr | 0.1 |
| 72 | 0.8 | 1.5 | 0.1 | 5 | | 1.8 | 5 | 0.01 | 0.2 | 0.01 | 7 | Zr | 0.001 |
| 73 | 0.8 | 1.5 | 0.1 | | 10 | 4.35 | 7 | | 2.8 | 1.2 | 3 | Zr | 0.001 |
| 74 | 0.8 | 1.5 | 0.1 | 5 | | 1.8 | 5 | 0.01 | 0.2 | 0.01 | 7 | As | 1.5 |
| 75 | 0.8 | 1.5 | 0.1 | | 10 | 4.35 | 7 | | 2.8 | 1.2 | 3 | As | 1.5 |
| 76 | 0.8 | 1.5 | 0.1 | 5 | | 1.8 | 5 | 0.01 | 0.2 | 0.01 | 7 | As | 1 |
| 77 | 0.8 | 1.5 | 0.1 | | 10 | 4.35 | 7 | | 2.8 | 1.2 | 3 | As | 1 |
| 78 | 0.8 | 1.5 | 0.1 | 5 | | 1.8 | 5 | 0.01 | 0.2 | 0.01 | 7 | As | 0.1 |
| 79 | 0.8 | 1.5 | 0.1 | | 10 | 4.35 | 7 | | 2.8 | 1.2 | 3 | As | 0.1 |
| 80 | 0.8 | 1.5 | 0.1 | 5 | | 1.8 | 5 | 0.01 | 0.2 | 0.01 | 7 | As | 0.001 |
| 81 | 0.8 | 1.5 | 0.1 | | 10 | 4.35 | 7 | | 2.8 | 1.2 | 3 | As | 0.001 |
| 82 | 0.8 | 1.5 | 0.1 | 5 | | 1.8 | 5 | 0.01 | 0.2 | 0.01 | 7 | Li | 1.5 |
| 83 | 0.8 | 1.5 | 0.1 | | 10 | 4.35 | 7 | | 2.8 | 1.2 | 3 | Li | 1.5 |
| 84 | 0.8 | 1.5 | 0.1 | 5 | | 1.8 | 5 | 0.01 | 0.2 | 0.01 | 7 | Li | 1 |
| 85 | 0.8 | 1.5 | 0.1 | | 10 | 4.35 | 7 | | 2.8 | 1.2 | 3 | Li | 1 |
| 86 | 0.8 | 1.5 | 0.1 | 5 | | 1.8 | 5 | 0.01 | 0.2 | 0.01 | 7 | Li | 0.1 |
| 87 | 0.8 | 1.5 | 0.1 | | 10 | 4.35 | 7 | | 2.8 | 1.2 | 3 | Li | 0.1 |
| 88 | 0.8 | 1.5 | 0.1 | 5 | | 1.8 | 5 | 0.01 | 0.2 | 0.01 | 7 | Li | 0.001 |
| 89 | 0.8 | 1.5 | 0.1 | | 10 | 4.35 | 7 | | 2.8 | 1.2 | 3 | Li | 0.001 |
| 90 | 0.8 | 1.5 | 0.1 | 5 | | 1.8 | 5 | 0.01 | 0.2 | 0.01 | 7 | Y | 1.5 |
| 91 | 0.8 | 1.5 | 0.1 | | 10 | 4.35 | 7 | | 2.8 | 1.2 | 3 | Y | 1.5 |
| 92 | 0.8 | 1.5 | 0.1 | 5 | | 1.8 | 5 | 0.01 | 0.2 | 0.01 | 7 | Y | 1 |
| 93 | 0.8 | 1.5 | 0.1 | | 10 | 4.35 | 7 | | 2.8 | 1.2 | 3 | Y | 1 |
| 94 | 0.8 | 1.5 | 0.1 | 5 | | 1.8 | 5 | 0.01 | 0.2 | 0.01 | 7 | Y | 0.1 |
| 95 | 0.8 | 1.5 | 0.1 | | 10 | 4.35 | 7 | | 2.8 | 1.2 | 3 | Y | 0.1 |
| 96 | 0.8 | 1.5 | 0.1 | 5 | | 1.8 | 5 | 0.01 | 0.2 | 0.01 | 7 | Y | 0.001 |
| 97 | 0.8 | 1.5 | 0.1 | | 10 | 4.35 | 7 | | 2.8 | 1.2 | 3 | Y | 0.001 |
| 98 | 0.8 | 1.5 | 0.1 | 5 | | 1.8 | 5 | 0.01 | 0.2 | 0.01 | 7 | Ca | 1.5 |
| 99 | 0.8 | 1.5 | 0.1 | | 10 | 4.35 | 7 | | 2.8 | 1.2 | 3 | Ca | 1.5 |
| 100 | 0.8 | 1.5 | 0.1 | 5 | | 1.8 | 5 | 0.01 | 0.2 | 0.01 | 7 | Ca | 1 |
| 101 | 0.8 | 1.5 | 0.1 | | 10 | 4.35 | 7 | | 2.8 | 1.2 | 3 | Ca | 1 |
| 102 | 0.8 | 1.5 | 0.1 | 5 | | 1.8 | 5 | 0.01 | 0.2 | 0.01 | 7 | Ca | 0.1 |
| 103 | 0.8 | 1.5 | 0.1 | | 10 | 4.35 | 7 | | 2.8 | 1.2 | 3 | Ca | 0.1 |
| 104 | 0.8 | 1.5 | 0.1 | 5 | | 1.8 | 5 | 0.01 | 0.2 | 0.01 | 7 | Ca | 0.001 |
| 105 | 0.8 | 1.5 | 0.1 | | 10 | 4.35 | 7 | | 2.8 | 1.2 | 3 | Ca | 0.001 |
| 106 | 0.8 | 1.5 | 0.1 | 5 | | 1.8 | 5 | 0.01 | 0.2 | 0.01 | 7 | V | 1.5 |
| 107 | 0.8 | 1.5 | 0.1 | | 10 | 4.35 | 7 | | 2.8 | 1.2 | 3 | V | 1.5 |
| 108 | 0.8 | 1.5 | 0.1 | 5 | | 1.8 | 5 | 0.01 | 0.2 | 0.01 | 7 | V | 1 |
| 109 | 0.8 | 1.5 | 0.1 | | 10 | 4.35 | 7 | | 2.8 | 1.2 | 3 | V | 1 |
| 110 | 0.8 | 1.5 | 0.1 | 5 | | 1.8 | 5 | 0.01 | 0.2 | 0.01 | 7 | V | 0.1 |
| 111 | 0.8 | 1.5 | 0.1 | | 10 | 4.35 | 7 | | 2.8 | 1.2 | 3 | V | 0.1 |
| 112 | 0.8 | 1.5 | 0.1 | 5 | | 1.8 | 5 | 0.01 | 0.2 | 0.01 | 7 | V | 0.001 |
| 113 | 0.8 | 1.5 | 0.1 | | 10 | 4.35 | 7 | | 2.8 | 1.2 | 3 | V | 0.001 |
| 114 | 0.8 | 1.5 | 0.1 | 5 | | 1.8 | 5 | 0.01 | 0.2 | 0.01 | 7 | Mo | 1.5 |
| 115 | 0.8 | 1.5 | 0.1 | | 10 | 4.35 | 7 | | 2.8 | 1.2 | 3 | Mo | 1.5 |
| 116 | 0.8 | 1.5 | 0.1 | 5 | | 1.8 | 5 | 0.01 | 0.2 | 0.01 | 7 | Mo | 1 |
| 117 | 0.8 | 1.5 | 0.1 | | 10 | 4.35 | 7 | | 2.8 | 1.2 | 3 | Mo | 1 |
| 118 | 0.8 | 1.5 | 0.1 | 5 | | 1.8 | 5 | 0.01 | 0.2 | 0.01 | 7 | Mo | 0.1 |
| 119 | 0.8 | 1.5 | 0.1 | | 10 | 4.35 | 7 | | 2.8 | 1.2 | 3 | Mo | 0.1 |
| 120 | 0.8 | 1.5 | 0.1 | 5 | | 1.8 | 5 | 0.01 | 0.2 | 0.01 | 7 | Mo | 0.001 |
| 121 | 0.8 | 1.5 | 0.1 | | 10 | 4.35 | 7 | | 2.8 | 1.2 | 3 | Mo | 0.001 |
| 122 | 0.8 | 1.5 | 0.1 | 5 | | 1.8 | 5 | 0.01 | 0.2 | 0.01 | 7 | W | 1.5 |
| 123 | 0.8 | 1.5 | 0.1 | | 10 | 4.35 | 7 | | 2.8 | 1.2 | 3 | W | 1.5 |
| 124 | 0.8 | 1.5 | 0.1 | 5 | | 1.8 | 5 | 0.01 | 0.2 | 0.01 | 7 | W | 1 |
| 125 | 0.8 | 1.5 | 0.1 | | 10 | 4.35 | 7 | | 2.8 | 1.2 | 3 | W | 1 |
| 126 | 0.8 | 1.5 | 0.1 | 5 | | 1.8 | 5 | 0.01 | 0.2 | 0.01 | 7 | W | 0.1 |
| 127 | 0.8 | 1.5 | 0.1 | | 10 | 4.35 | 7 | | 2.8 | 1.2 | 3 | W | 0.1 |
| 128 | 0.8 | 1.5 | 0.1 | 5 | | 1.8 | 5 | 0.01 | 0.2 | 0.01 | 7 | W | 0.001 |
| 129 | 0.8 | 1.5 | 0.1 | | 10 | 4.35 | 7 | | 2.8 | 1.2 | 3 | W | 0.001 |
| 130 | 0.8 | 1.5 | 0.1 | 5 | | 1.8 | 5 | 0.01 | 0.2 | 0.01 | 7 | Sb | 1.5 |
| 131 | 0.8 | 1.5 | 0.1 | | 10 | 4.35 | 7 | | 2.8 | 1.2 | 3 | Sb | 1.5 |
| 132 | 0.8 | 1.5 | 0.1 | 5 | | 1.8 | 5 | 0.01 | 0.2 | 0.01 | 7 | Sb | 1 |
| 133 | 0.8 | 1.5 | 0.1 | | 10 | 4.35 | 7 | | 2.8 | 1.2 | 3 | Sb | 1 |
| 134 | 0.8 | 1.5 | 0.1 | 5 | | 1.8 | 5 | 0.01 | 0.2 | 0.01 | 7 | Sb | 0.1 |
| 135 | 0.8 | 1.5 | 0.1 | | 10 | 4.35 | 7 | | 2.8 | 1.2 | 3 | Sb | 0.1 |
| 136 | 0.8 | 1.5 | 0.1 | 5 | | 1.8 | 5 | 0.01 | 0.2 | 0.01 | 7 | Sb | 0.001 |
| 137 | 0.8 | 1.5 | 0.1 | | 10 | 4.35 | 7 | | 2.8 | 1.2 | 3 | Sb | 0.001 |
| 138 | 0.8 | 1.5 | 0.1 | 5 | | 1.8 | 5 | 0.01 | 0.2 | 0.01 | 7 | Se | 1.5 |
| 139 | 0.8 | 1.5 | 0.1 | | 10 | 4.35 | 7 | | 2.8 | 1.2 | 3 | Se | 1.5 |
| 140 | 0.8 | 1.5 | 0.1 | 5 | | 1.8 | 5 | 0.01 | 0.2 | 0.01 | 7 | Se | 1 |
| 141 | 0.8 | 1.5 | 0.1 | | 10 | 4.35 | 7 | | 2.8 | 1.2 | 3 | Se | 1 |
| 142 | 0.8 | 1.5 | 0.1 | 5 | | 1.8 | 5 | 0.01 | 0.2 | 0.01 | 7 | Se | 0.1 |
| 143 | 0.8 | 1.5 | 0.1 | | 10 | 4.35 | 7 | | 2.8 | 1.2 | 3 | Se | 0.1 |
| 144 | 0.8 | 1.5 | 0.1 | 5 | | 1.8 | 5 | 0.01 | 0.2 | 0.01 | 7 | Se | 0.001 |
| 145 | 0.8 | 1.5 | 0.1 | | 10 | 4.35 | 7 | | 2.8 | 1.2 | 3 | Se | 0.001 |
| 146 | 0.8 | 1.5 | 0.1 | 5 | | 1.8 | 5 | 0.01 | 0.2 | 0.01 | 7 | Te | 1.5 |
| 147 | 0.8 | 1.5 | 0.1 | | 10 | 4.35 | 7 | | 2.8 | 1.2 | 3 | Te | 1.5 |
| 148 | 0.8 | 1.5 | 0.1 | 5 | | 1.8 | 5 | 0.01 | 0.2 | 0.01 | 7 | Te | 1 |
| 149 | 0.8 | 1.5 | 0.1 | | 10 | 4.35 | 7 | | 2.8 | 1.2 | 3 | Te | 1 |
| 150 | 0.8 | 1.5 | 0.1 | 5 | | 1.8 | 5 | 0.01 | 0.2 | 0.01 | 7 | Te | 0.1 |
| 151 | 0.8 | 1.5 | 0.1 | | 10 | 4.35 | 7 | | 2.8 | 1.2 | 3 | Te | 0.1 |
| 152 | 0.8 | 1.5 | 0.1 | 5 | | 1.8 | 5 | 0.01 | 0.2 | 0.01 | 7 | Te | 0.001 |
| 153 | 0.8 | 1.5 | 0.1 | | 10 | 4.35 | 7 | | 2.8 | 1.2 | 3 | Te | 0.001 |
| 154 | 0.8 | 1.5 | 0.1 | 5 | | 1.8 | 5 | 0.01 | 0.2 | 0.01 | 7 | Bi | 1.5 |
| 155 | 0.8 | 1.5 | 0.1 | | 10 | 4.35 | 7 | | 2.8 | 1.2 | 3 | Bi | 1.5 |
| 156 | 0.8 | 1.5 | 0.1 | 5 | | 1.8 | 5 | 0.01 | 0.2 | 0.01 | 7 | Bi | 1 |
| 157 | 0.8 | 1.5 | 0.1 | | 10 | 4.35 | 7 | | 2.8 | 1.2 | 3 | Bi | 1 |
| 158 | 0.8 | 1.5 | 0.1 | 5 | | 1.8 | 5 | 0.01 | 0.2 | 0.01 | 7 | Bi | 0.1 |
| 159 | 0.8 | 1.5 | 0.1 | | 10 | 4.35 | 7 | | 2.8 | 1.2 | 3 | Bi | 0.1 |
| 160 | 0.8 | 1.5 | 0.1 | 5 | | 1.8 | 5 | 0.01 | 0.2 | 0.01 | 7 | Bi | 0.001 |
| 161 | 0.8 | 1.5 | 0.1 | | 10 | 4.35 | 7 | | 2.8 | 1.2 | 3 | Bi | 0.001 |
| 162 | 0.8 | 1.5 | 0.1 | 5 | | 1.8 | 5 | 0.01 | 0.2 | 0.01 | 7 | B | 1.5 |
| 163 | 0.8 | 1.5 | 0.1 | | 10 | 4.35 | 7 | | 2.8 | 1.2 | 3 | B | 1.5 |
| 164 | 0.8 | 1.5 | 0.1 | 5 | | 1.8 | 5 | 0.01 | 0.2 | 0.01 | 7 | B | 1 |
| 165 | 0.8 | 1.5 | 0.1 | | 10 | 4.35 | 7 | | 2.8 | 1.2 | 3 | B | 1 |
| 166 | 0.8 | 1.5 | 0.1 | 5 | | 1.8 | 5 | 0.01 | 0.2 | 0.01 | 7 | B | 0.001 |
| 167 | 0.8 | 1.5 | 0.1 | | 10 | 4.35 | 7 | | 2.8 | 1.2 | 3 | B | 0.001 |
| 168 | 0.8 | 1.5 | 0.1 | 5 | | 1.8 | 5 | 0.01 | 0.2 | 0.01 | 7 | Nb | 1.5 |
| 169 | 0.8 | 1.5 | 0.1 | | 10 | 4.35 | 7 | | 2.8 | 1.2 | 3 | Nb | 1.5 |
| 170 | 0.8 | 1.5 | 0.1 | 5 | | 1.8 | 5 | 0.01 | 0.2 | 0.01 | 7 | Nb | 1 |
| 171 | 0.8 | 1.5 | 0.1 | | 10 | 4.35 | 7 | | 2.8 | 1.2 | 3 | Nb | 1 |
| 172 | 0.8 | 1.5 | 0.1 | 5 | | 1.8 | 5 | 0.01 | 0.2 | 0.01 | 7 | Nb | 0.1 |
| 173 | 0.8 | 1.5 | 0.1 | | 10 | 4.35 | 7 | | 2.8 | 1.2 | 3 | Nb | 0.1 |
| 174 | 0.8 | 1.5 | 0.1 | 5 | | 1.8 | 5 | 0.01 | 0.2 | 0.01 | 7 | Nb | 0.001 |
| 175 | 0.8 | 1.5 | 0.1 | | 10 | 4.35 | 7 | | 2.8 | 1.2 | 3 | Nb | 0.001 |
| 176 | 0.8 | 1.5 | 0.1 | 5 | | 1.8 | 5 | 0.01 | 0.2 | 0.01 | 7 | Pd | 1.5 |
| 177 | 0.8 | 1.5 | 0.1 | | 10 | 4.35 | 7 | | 2.8 | 1.2 | 3 | Pd | 1.5 |
| 178 | 0.8 | 1.5 | 0.1 | 5 | | 1.8 | 5 | 0.01 | 0.2 | 0.01 | 7 | Pd | 1 |
| 179 | 0.8 | 1.5 | 0.1 | | 10 | 4.35 | 7 | | 2.8 | 1.2 | 3 | Pd | 1 |
| 180 | 0.8 | 1.5 | 0.1 | 5 | | 1.8 | 5 | 0.01 | 0.2 | 0.01 | 7 | Pd | 0.1 |
| 181 | 0.8 | 1.5 | 0.1 | | 10 | 4.35 | 7 | | 2.8 | 1.2 | 3 | Pd | 0.1 |
| 182 | 0.8 | 1.5 | 0.1 | 5 | | 1.8 | 5 | 0.01 | 0.2 | 0.01 | 7 | Pd | 0.001 |
| 183 | 0.8 | 1.5 | 0.1 | | 10 | 4.35 | 7 | | 2.8 | 1.2 | 3 | Pd | 0.001 |

The determination of the tendency towards fretting of this copper base alloy was carried out according to a test for tendency towards fretting, which all multilayer sliding bearing elements 1 according to the examples in Table 2 were subjected to. The measuring values were normalized to a multi-layer sliding bearing element of a known alloy from CuPb22Sn. This alloy was defined with 100% fretting load. Compared thereto, the alloys according to Table 2 have values of between 70% and 105%, which are not only very good values with regard to the absence of lead but even surpass the lead-containing alloy.

In further tests, it was found that with the addition of boron it is possible to set the hardness of the copper base alloy in combination with cooling of the melt within certain limits. Hence, after quick cooling of the boron phases can be deposited in the border region to the steel of the supporting metal layer 3, whereby the change of the mechanical properties at the transition of the further layer 4 to the supporting metal layer 3 can be set. With a comparatively slower cooling of the melt, in turn, the copper base alloy can be set to be softer. In the alternative or in addition to this, the precipitation of these boron phases in the border region to the steel of the supporting metal layer 3 can also be influenced via the quantitative proportion of boron in the copper base alloy. Of course, boron phases can also be contained in the entire layer 4.

With this embodiment variant, it is possible to produce a hardness gradient in the further layer 4 and in further consequence in the multi-layer sliding bearing element 1 already by production, i.e. during the and by the solidification of the copper base alloy (casting onto the layer arranged below the further layer 4). Thus, no further processing is required for producing this hardness gradient.

By the hardness gradient, the hardness decreases from the bonding zone, i.e. the border region to the steel of the supporting metal layer 3 or the layer arranged below the further layer 4 towards the (in the radial direction) opposite surface of the further layer 4. Thereby, a low hardness can be present in the region of the sliding surface, which results in an improved adaptability of the further layer 4. On the other hand, by the comparatively higher hardness in the bonding zone, an abrupt hardness transition to the supporting metal layer 3 or the layer arranged below the further layer 4 can be prevented, whereby mechanical stresses can be better avoided and/or reduced. This, in turn, improves the fatigue strength and/or service life of the multi-layer sliding bearing element 1.

The concentration of the boron phases thus increased from the (radially) inner surface of the further layer 4 in the direction towards the supporting metal layer 3 or the layer arranged below the further layer 4 of the multi-layer sliding bearing element 1, wherein the concentration of the boron phases in the bonding zone is largest at the transition to the supporting metal layer 3 or the layer arranged below the further layer 4 of the multi-layer sliding bearing element 1.

Preferably, for the formation of the hardness gradient in the further layer 4, the copper base alloy is applied onto the supporting metal layer 3 or the layer arranged below the further layer 4 by means of a centrifugal casting method. However, other methods, such as a tape casting method, are also possible.

The boron phases predominantly are iron boron phases. However, other boron phases with alloying elements of the copper base alloy can also be formed. The boron phases can in general also occur in other regions of the copper base alloy.

It is possible in the multi-layer sliding bearing element 1 to further develop tribologically favorable layers. For example, sulfide deposits can be incorporated into the uppermost layer. Boron has a supporting effect in the formation of these deposits.

The invention further relates to a method for producing a multi-layer sliding bearing element 1, for which a composite material comprising a supporting metal layer 3 and a further layer 4, in particular a sliding layer 9, as well as optionally an intermediate layer between the supporting metal layer 3 and the further layer 4, is produced. The further layer 4 is formed from a cast alloy of a lead-free copper base alloy, in which sulfide precipitates 10 are contained. For producing the cast alloy, between 0.1 wt. % and 3 wt. % sulfur, between 0.01 wt. % and 4 wt. % iron, between 0 wt. %, in particular 0.001 wt. %, and 2 wt. % phosphorus, at least one element from a first group consisting of zinc, tin, aluminum, manganese, nickel, silicon, chromium, indium of in total between 0.1 wt. % and 49 wt. %, wherein the proportion of zinc amounts to between 0 wt. % and 45 wt. %, the proportion of tin amounts to between 0 wt. % and 40 wt. %, the proportion of aluminum amounts to between 0 wt. % and 15 wt. %, the proportion of manganese amounts to between 0 wt. % and 10 wt. %, the proportion of nickel amounts to between 0 wt. % and 10 wt. %, the proportion of silicon amounts to between 0 wt. % and 10 wt. %, the proportion of chromium amounts to between 0 wt. % and 2 wt. %, and the proportion of indium amounts to between 0 wt. % and 10 wt. %, and at least one element from a second group consisting of silver, magnesium, indium, cobalt, titanium, zirconium, arsenic, lithium, yttrium, calcium, vanadium, molybdenum, tungsten, antimony, selenium, tellurium, bismuth, niobium, palladium each to a proportion of between 0 wt. % and 1.5 wt. %, wherein the summary proportion of the elements of the second group amounts to between 0 wt. % and 2 wt. %, are used. The balance adding up to 100 wt. % is constituted by copper as well as by impurities originating from the production of the elements.

For producing the cast alloy, the further indications of quantities mentioned in Table 1 above can be used as well.

The exemplary embodiments show and/or describe possible embodiment variants, while it should be noted at this point that diverse combinations of the individual embodiment variants are also possible.

Finally, as a matter of form, it should be noted that for ease of understanding of the structure of the multi-layer sliding bearing element 1 and/or of the further layer 4, these are not obligatorily depicted to scale. Although only a few embodiments of the present invention have been shown and described, it is to be understood that many changes and modifications may be made thereunto without departing from the spirit and scope of the invention.

### LIST OF REFERENCE NUMBERS

1 multi-layer sliding bearing element
2 sliding bearing element body
3 supporting metal layer
4 layer
5 bearing metal layer
6 running-in layer
7 sliding bearing element
8 sliding bearing
9 sliding layer
10 precipitate
11 total layer thickness
12 partial layer
13 layer thickness
14 surface
15 particle diameter

1. A multi-layer sliding bearing element (1) made from a composite material comprising a supporting metal layer (3) and a further layer (4), in particular a sliding layer (9), as well as optionally an intermediate layer between the supporting metal layer (3) and the further layer (4), wherein the further layer (4) is formed of a cast alloy of a lead-free copper base alloy, in which sulfide precipitates (10) are contained, wherein the copper base alloy contains between 0.1 wt. % and 3 wt. % sulfur, between 0.01 wt. % and 4 wt. % iron, between 0 wt. %, in particular 0.001 wt. %, and 2 wt. % phosphorus, at least one element from a first group consisting of zinc, tin, aluminum, manganese, nickel, silicon, chromium, indium of in total between 0.1 wt. % and 49 wt. %, wherein the proportion of zinc amounts to between 0 wt. % and 45 wt. %, the proportion of tin amounts to between 0 wt. % and 40 wt. %, the proportion of aluminum amounts to between 0 wt. % and 15 wt. %, the proportion of manganese amounts to between 0 wt. % and 10 wt. %, the proportion of nickel amounts to between 0 wt. % and 10 wt. %, the proportion of silicon amounts to between 0 wt. % and 10 wt. %, the proportion of chromium amounts to between 0 wt. % and 2 wt. %, and the proportion of indium amounts to between 0 wt. % and 10 wt. %, and at least one element from a second group consisting of silver, magnesium, indium, cobalt, titanium, zirconium, arsenic, lithium, yttrium, calcium, vanadium, molybdenum, tungsten, antimony, selenium, tellurium, bismuth, niobium, palladium each to a proportion of between 0 wt. % and 1.5 wt. %, wherein the summary proportion of the elements of the second group amounts to between 0 wt. % and 2 wt. %, and the balance adding up to 100 wt. % being constituted by copper and impurities originating from the production of the elements.

2. The multi-layer sliding bearing element (1) according to claim 1, wherein the copper base alloy of the further layer (4) contains either zinc or tin.

3. The multi-layer sliding bearing element (1) according to claim 1, wherein the summary proportion of the elements from the first group consisting of zinc, tin, aluminum, manganese, nickel, silicon, chromium amounts to between 0.5 wt. % and 15 wt. %.

4. The multi-layer sliding bearing element (1) according to claim 1, wherein the copper base alloy of the further layer (4) contains between 0.01 wt. % and 5 wt. % zinc.

5. The multi-layer sliding bearing element (1) according to claim 1, wherein the copper base alloy of the further layer (4) contains between 0.01 wt. % and 10 wt. % tin.

6. The multi-layer sliding bearing element (1) according to claim 1, wherein the copper base alloy of the further layer (4) contains between 0.01 wt. % and 7.5 wt. % aluminum.

7. The multi-layer sliding bearing element (1) according to claim 1, wherein the copper base alloy of the further layer (4) contains between 0.01 wt. % and 5 wt. % manganese.

8. The multi-layer sliding bearing element (1) according to claim 1, wherein the copper base alloy of the further layer (4) contains between 0.01 wt. % and 5 wt. %, in particular between 0.01 wt. % and 2 wt. % nickel.

9. The multi-layer sliding bearing element (1) according to claim 1, wherein the copper base alloy of the further layer (4) contains between 0.01 wt. % and 7 wt. %, in particular between 0.01 wt. % and 3 wt. % silicon.

10. The multi-layer sliding bearing element (1) according to claim 1, wherein the copper base alloy of the further layer (4) contains between 0.01 wt. % and 1.5 wt. %, in particular between 0.01 wt. % and 1 wt. %, chromium.

11. The multi-layer sliding bearing element (1) according to claim 1, wherein the copper base alloy of the further layer (4) contains between 0.3 wt. % and 0.8 wt. % sulfur.

12. The multi-layer sliding bearing element (1) according to claim 1, wherein the copper base alloy of the further layer (4) contains between 0.01 wt. % and 0.1 wt. % phosphorus.

13. The multi-layer sliding bearing element (1) according to claim 1, wherein the copper base alloy of the further layer (4) contains between 0.3 wt. % and 1.5 wt. % iron.

14. The multi-layer sliding bearing element (1) according to claim 1, wherein the copper base alloy of the further layer (4) additionally contains between 0.001 wt. % and 1.5 wt. %, in particular between 0.001 wt. % and 1 wt. %, boron.

15. The multi-layer sliding bearing element (1) according to claim 1, wherein the sulfide precipitates (10) are present being homogeneously distributed within the entire further layer (4).

16. The multi-layer sliding bearing element (1) according to claim 1, wherein the sulfide precipitates (10) are formed merely within a partial layer (12) of the copper base alloy of the further layer (4).

17. The multi-layer sliding bearing element (1) according to claim 16, wherein the partial layer (12) comprises a layer thickness (13) amounting to between 5% and 85% of the total layer thickness (11) of the further layer (4).

18. The multi-layer sliding bearing element (1) according to claim 1, wherein the sulfide precipitates consist of a mixture of copper sulfides and iron sulfides to at least 50 area-%.

19. The multi-layer sliding bearing element (1) according to claim 18, wherein the proportion of copper sulfides in the mixture of copper sulfides and iron sulfides amounts to at least 60 area-%.
